(19) United States
(12) Patent Application Publication
(10) Pub. No.: US 2015/0039534 A1
(43) Pub. Date: Feb. 5, 2015

(54) INVENTION PROTECTION AND DEVELOPMENT SYSTEMS

(71) Applicant: Codega Holdings LLC, Irvington, NY (US)

(72) Inventors: Lavi Erissson, Irvington, NY (US); Avraham Hermon, Bracha (IL)

(73) Assignee: Codega Holdings LLC, Irvington, NY (US)

(21) Appl. No.: 14/447,435

(22) Filed: Jul. 30, 2014

Related U.S. Application Data
(60) Provisional application No. 61/860,440, filed on Jul. 31, 2013.

(51) Int. Cl. G06Q 50/18; G06Q 10/10

(52) U.S. Cl. CPC G06Q 50/184; G06Q 10/101; G06Q 40/06
USPC 705/36 R; 705/310; 705/300

(57) ABSTRACT

An embodiment of the invention relates to a crowd-sourcing invention development system (CIDS) and methods associated with the system to aid inventors, at no cost or at minimal cost, to develop their ideas and to file patent applications based on their ideas. According to embodiments of the invention, CIDS facilitates investment in an inventor's invention by exposing potential investors to inventions at preliminary stages of invention development, allowing investors to fund activities such as searching and patent application drafting and filing. Investors may continue to invest after patent application drafting.

According to an embodiment of the invention, CIDS users may assist invention development or prior art searching by submitting relevant information via the CIDS website. A submitter may be rewarded by being granted rights or credits to be exchanged for rights in an invention submitted to the CIDS website.

### RELATED APPLICATIONS

The present application claims the benefit under 35 U.S.C. 119(e) of U.S. Provisional Application 61/860,440 filed on Jul. 31, 2013, the disclosure of which is incorporated herein by reference.

### TECHNICAL FIELD

Embodiments of the invention relate to systems and methods for assisting inventors in developing, protecting and marketing their inventions.

### BACKGROUND

Many people from all walks of life have ideas for patentable products or methods. Although many inventors work in specialized technological fields and are employed in companies, universities or organizations which are familiar in protecting their employees' inventions, some inventors are not experts in any technological field, and have ideas for patentable products or methods in fields not related to their work. This latter group of inventors may have difficulty learning about processes to protect their inventions, such as performing patentability searches or filing of patent applications.

Although the United States Patent and Trademark Office maintains programs to assist “small entity” inventors in filing patent applications and to lower costs of filing, patent searching and filing is often an expensive endeavor for a private individual. Much of the high cost associated with patent filing stem from attorney fees for drafting and filing patent applications. Additionally, patent applicants frequently are interested in filing patent applications internationally. Although the Patent Cooperation Treaty (PCT) simplifies the process associated with obtaining patent protection internationally, costs, such as official fees and attorney fees associated with such filings are still high and may be beyond the reach of many inventors who are private individuals.

### SUMMARY

An embodiment of the invention relates to a crowd-sourcing invention development system (CIDS) and methods associated with the system to aid inventors, at no cost or at minimal cost, to develop their ideas and to file patent applications based on their ideas. CIDS may be useful in assisting the inventors in searching their inventions, filing patent applications, developing their inventions and licensing the patent applications. According to embodiments of the invention, CIDS facilitates investment in an inventor's invention by exposing potential investors to inventions at preliminary stages of invention development, allowing investors to fund activities such as searching and patent application drafting and filing. Investors may continue to invest after patent application drafting.

According to an embodiment of the invention, CIDS may utilize a website to facilitate inventor submission of inventions and investment by investors. The CIDS website may generate metrics based on inventor parameters, investor interest or investor bidding parameters and display those metrics to assist investors in deciding on investment. Investors may purchase shares or rights in an invention on a fixed-price per share basis, or through a bidding system facilitated by the CIDS website. “Rights in an invention” or may refer to any one or combination of shares or ownership rights in the invention, equity or stock options in the legal entity which owns the invention, or rights in future profits, license agreements, sales or royalties associated with the invention.

According to an embodiment of the invention, CIDS users may assist invention development by submitting relevant prior art relating to an invention via the CIDS website. A prior art submitter may be rewarded by being granted rights or credits to be exchanged for rights in an invention submitted to the CIDS website. CIDS users may rate prior art submitted by other CIDS users based on the similarity between prior art and the invention. These prior art submitters and/or raters may be rewarded by being grated rights or credits to be exchanged for rights in an invention submitted to the CIDS website.

According to an embodiment of the invention, CIDS users may assist invention development by submitting invention development data via the CIDS website. An example of invention development data is data relating to feasibility of using an invention to address a known problem in the field. A development data submitter may be rewarded by being granted rights or credits to be exchanged for rights in an invention submitted to the CIDS website.

The aforementioned CIDS based processes are efficient ways in assisting an inventor in protecting and/or developing his invention without the need for raising large amounts of capital which is typically associated with protecting and developing inventions.

In the discussion unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 depicts a block diagram of a CIDS according to an embodiment of the invention;

FIG. 2 depicts a block diagram of a CIDS according to an embodiment of the invention;

FIG. 3 depicts a block diagram of a CIDS according to an embodiment of the invention;

FIG. 4 depicts a block diagram of a CIDS according to an embodiment of the invention; and

FIG. 5 depicts a screenshot of an invention showcase website according to an embodiment of the invention.

### DETAILED DESCRIPTION

As mentioned above, embodiments of the invention relate to a CIDS website. Embodiments of the invention can utilize the World Wide Web (WWW) or (Web) site accessible via the Internet. As is well known to those skilled in the art, the term “Internet” refers to the collection of networks and routers that use the Transmission Control Protocol/Internet Protocol (“TCP/IP”) to communicate with one another. The Internet can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize analog telephone digital T-1 lines, T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as JAVA applets, instant messaging, e-mail, browser plug-ins, Macromedia Flash, chat and others. Other interactive hypertext environments may include proprietary environments such as those provided by online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive environment with regard to the present application.

A website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs for execution on a remote computer. Likewise, a web server may also include facilities for executing scripts and other application programs on the web server itself.

According to embodiments of the invention, a server and/or a terminal connected via a network to a server may comprise non-transient computer readable medium including instructions to perform CIDS methods.

In addition to use of remote computers according to embodiments of the invention, mobile communication devices such as a portable multifunction device, a “Smartphone”, a cellular communication device, a cellular phone, a tablet computer, a personal digital assistant (PDA) and/or a laptop computer may be used. Information may also be provided via stationary communication devices such as a desktop computer and/or a computer terminal.

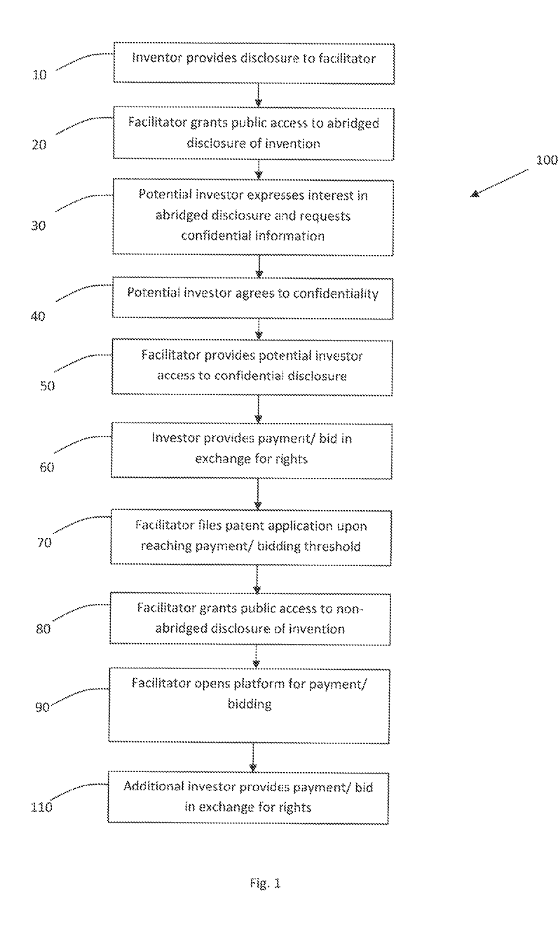

With reference to FIG. 1, process 100 is a CIDS process according to an embodiment of the invention. Process 100 allows an inventor to develop his or her invention with little to no cost, using a crowdfunding system which allows investors to invest in the invention before a patent application is filed and allows additional investors to continue to invest in the invention after a patent application has been filed, thereby covering costs of patent application drafting/filing and of further development. The crowdfunding system may be operated by a facilitator. An inventor and/or a facilitator may receive feedback from number and frequency of investment at various stages of the process in order to gauge the potential of the invention.

According to an embodiment of the invention, process 100 comprises block 10, in which an inventor provides a disclosure of an invention to a facilitator. The facilitator may be an operator of a website which allows for communication, either textual or verbal, between an inventor, a plurality of investors, and the operator of the website.

In exchange for a disclosure of an invention, an inventor may enter an agreement with a facilitator in order to assign rights to the invention to the facilitator. In exchange for assignment of rights to the invention to the facilitator, the facilitator may commit to provide inventor with future rights, profits and/or royalties associated with the invention.

Upon receipt of a disclosure of the invention according to block 10, a facilitator may devise a development scheme comprising development milestones. The development milestones may relate to various activities which will be performed to facilitate development of the invention, including, but not limited to, research milestones, market milestones and patent milestones. Each milestone may be associated with a milestone cost. The facilitator may perform a search to ascertain that the invention is patentable. The facilitator may also ascertain the market value of the invention based on market research.

Process 100 further comprises block 20, in which a facilitator grants public access to an abridged disclosure of the invention. According to an embodiment of the invention, public access is granted via a website which allows internet users to access the abridged disclosure. According to an embodiment of the invention, the abridged disclosure contains only non-confidential information. According to an embodiment of the invention, the abridged disclosure is listed on an invention showcase section of a website.

An invention showcase section of a website may comprise a hyperlink which allows an inventor to provide friends and/or family access to the inventor's abridged disclosure. The inventor may enter the website and for example, click on a “share” button which allows the inventor to share his abridged disclosure with a friend. The “share” button may generate an email or a social media message or post providing information regarding the invention, for example, investing-related information or a link to a website through which an investor can invest in the invention.

According to an embodiment of the invention, an inventor or a facilitator may choose to limit access to the abridged disclosure of an invention to a closed community of potential investors. For example, an inventor may indicate to facilitator that he or she is interested in obtaining investment from a group of investors comprising the inventor's friends and family. In such a situation, an inventor may receive a link to a webpage which is not accessible to members of the public. The webpage may comprise information about the inventor's invention which the inventor feels comfortable releasing to friends and family. The inventor may send a link to the webpage to friends and family. Once a patent application has been filed, the inventor and/or the facilitator may grant public access to the webpage, allowing for additional potential investors to invest in the invention.

According to an embodiment of the invention, the inventor or facilitator may choose to allow the facilitator to grant public access to an abridged disclosure of the invention. The inventor may designate certain friends and family and the inventor or facilitator may send a link to a webpage describing the invention to the friends and family. The members of inventor's friends and family who choose to invest in the inventor's invention may receive a preferential rate or a discount on price per share relative to members of the public who invest in the invention.

Process 100 further comprises block 30, in which a potential investor expresses interest in an abridged disclosure of an invention and requests confidential information. A potential investor may indicate by pressing a button on a website that he requests confidential information relating to the invention.

Process 100 further comprises block 40, in which a potential investor agrees to confidentiality. A potential investor may agree to confidentiality by identifying himself with his name, address and any other relevant identification criteria, and by electronically signing on a confidentiality agreement. The agreement to confidentiality may occur through a potential investor's interaction with the website.

Process 100 further comprises block 50, in which facilitator provides potential investor access to a confidential disclosure of the invention. The confidential disclosure may be provided electronically to the investor via, for example, a secure website. The confidential disclosure may be provided electronically to the investor through a virtual data room which allows the investor to view the confidential disclosure without the ability of saving copies of the disclosure or printing the disclosure.

Process 100 further comprises block 60, in which investor provides a payment, a commitment to pay or a bid, in exchange for rights in the invention. A payment or commitment to pay may be provided by authorizing charging a credit card or a bank account or another money transfer system. According to an embodiment of the invention, the investor provides a bid at a determined price for rights in the invention. The payment or commitment to pay or bid may be provided via a website.

According to an embodiment of the invention, the rights in the invention is a share or a plurality of shares in the invention. The share or plurality of shares may be transferred through an agreement between the facilitator and the investor. In addition to or alternatively to shares, securities in the facilitator company may be granted. In addition to or alternatively to shares, royalties or any other medium through which equity or rights to future equity may be used. This agreement may be agreed to by the investor electronically, for example, via a website.

Process 100 further comprises block 70, in which the facilitator files a patent application when funds submitted by investors reaches a financial threshold. According to an embodiment of the invention, the financial threshold amounts to the cost of drafting and filing a patent application.

Process 100 may comprise a plurality of milestones which may be met as development of the invention continues.

Process 100 further comprises block 80, in which the facilitator grants public access of a non-abridged disclosure of the invention. According to an embodiment of the invention, the non-abridged disclosure of the invention is listed in an invention showcase section of the website.

Process 100 further comprises block 90, in which a facilitator provides an additional potential investor access to a payment or bidding platform. The payment or bidding platform may allow an additional investor to invest in an invention after viewing a non-abridged disclosure of the invention. According to an embodiment of the invention, the payment or bidding platform may show a milestone related to the invention. According to an embodiment of the invention, the payment or bidding platform may be hosted on a website.

According to an embodiment of the invention, the cost per share for an additional investor investing after filing of a patent application on the invention may be higher than the cost per share for an investor investing before the filing of a patent application.

Process 100 further comprises block 110, in which additional investor provides a payment, a commitment to pay or a bid, in exchange for rights in the invention. A payment or commitment to pay may be provided by authorizing charging a credit card or a bank account or another money transfer system. According to an embodiment of the invention, the investor provides a bid at a determined price for rights in the invention. The payment or commitment to pay or bid may be provided via a website.

According to an embodiment of the invention, after block 10, facilitator may file a patent application before granting public access to the disclosure of the invention. The patent application may be a US provisional patent application. According to block 70, the facilitator may file an additional patent application. The additional patent application may be a non-provisional patent application, a PCT application or a provisional patent application.

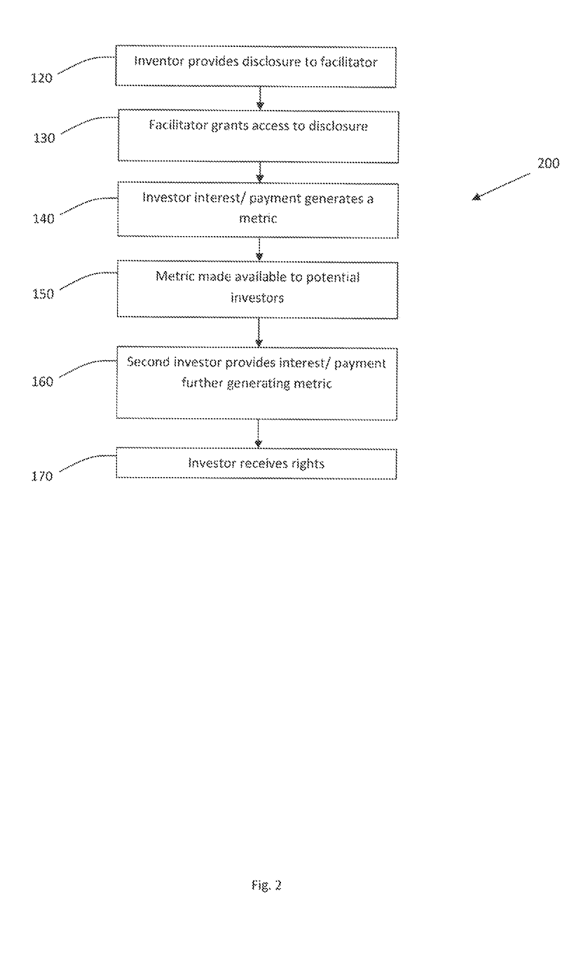

With reference to FIG. 2, process 200 is a CIDS process according to an embodiment of the invention. In process 200, a metric is generated based on investor interest in an invention. The metric may be viewed by other investors who may decide about investing in the invention based on the metric. The process may use crowdsourcing of actions of investors and potential investors to create metrics which can be used by potential investors to make investment decisions.

According to an embodiment of the invention, process 200 comprises block 120, in which an inventor provides a disclosure of the invention to a facilitator, optionally through a website. The communication between inventor and facilitator may be conducted under confidentiality.

Process 200 further comprises block 130 in which facilitator grants access to the disclosure to members of the public. The disclosure may be made available through a website, for example in an invention showcase section of a website, either as an abridged disclosure or a non-abridged disclosure. According to an embodiment of the invention, in addition to a disclosure, a website may also comprise information regarding acquiring rights to the invention. The information may include cost per share, an invention development scheme, potential market cap of the invention or other financial information relating to the invention. The facilitator may allow for payment or bidding in exchange for rights in the invention.

Process 200 further comprises block 140, in which investor input, for example investor interest or investor payment generates a metric. Investor interest may relate to, for example, the number of investors who requested information regarding an invention, for example, by clicking in a website relating to an invention. Investor payment may relate to, for example, the number of investors who invested in an invention. A metric may be, for example, any of the following:
the ratio of investors who invested in the invention relative to the number of investors who received information relating to the invention;
the number of views or requests for information relating to an invention per a unit time;
the relative experience of investors who expressed interest in the invention or paid for rights in the invention;
a rating of the invention by users of the website;
type of investors (corporate/individual etc.):
success of inventors on previous investments,
number of ads clicked on a website relating to the invention.

In addition to metrics relating to investors, a CIDS website may generate inventor-related metrics, for example:
number of inventions invented by the inventor;
number of commercialized inventions by the inventor;
education of the inventor; and
employment history of the inventor.

Any of the aforementioned metrics for each invention may be normalized, for example, on a scale of 1 to 10 relative to metrics associated with other inventions presented using a CIDS process via the facilitator.

According to an embodiment of the invention, a metric, or a plurality of metrics, generated as described above, may be used to determine the value of an invention. For example, a facilitator may value invention A at $10,000 based on a metric associated with 100 requests to view information, and may value invention B at $20,000 based on a metric associated with 200 requests to review information.

Process 200 further comprises block 150, in which a metric is made available to potential investors. A metric may be listed, for example on a website, in proximity to a description of the invention. A potential investor may browse the website and read brief descriptions of inventions and metrics associated with the inventions. The potential investor may arrange inventions on a basis of metrics, for example, the potential investor may select to view the inventions by “most heavily invested inventions” or “most viewed inventions in the last 24 hours.”

Process 200 further comprises block 160, in which a second investor payment generates a metric. The payment based metric may be a metric as described in block 140.

Process 200 further comprises block 170 in which a second investor receives rights in the invention in exchange for his payment.

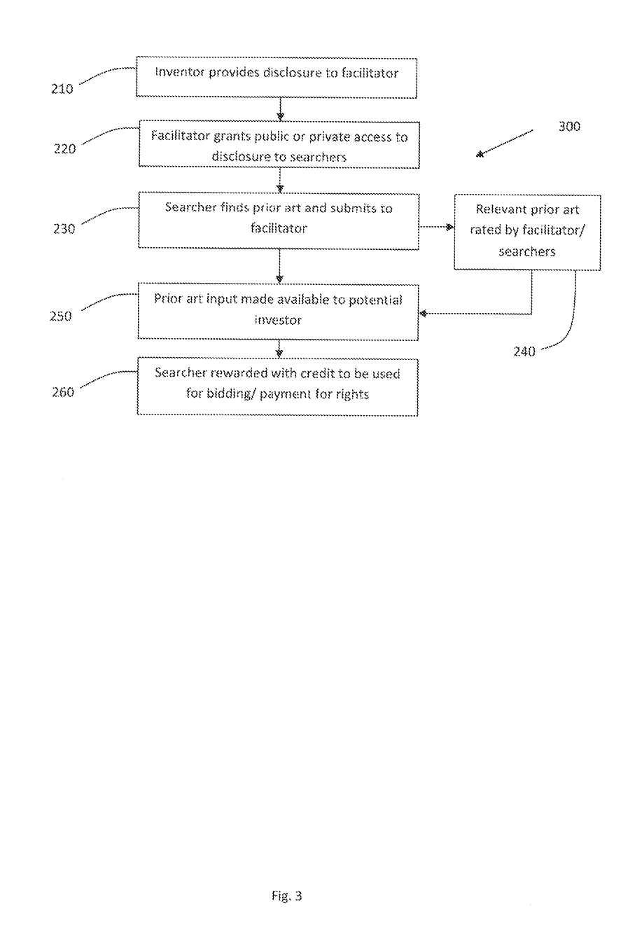

With reference to FIG. 3, process 300 comprises a CIDS process according to an embodiment of the invention. In process 300, an invention is provided to a facilitator and is then searched by one or more searchers. If a searcher finds prior art relevant to the patentability of the invention, he may submit it to the facilitator. The facilitator may then reward the searcher who found the relevant prior art with credit which can be used to purchase rights in an invention.

According to an embodiment of the invention, process 300 comprises block 210, in which an inventor provides a disclosure of the invention to a facilitator, optionally through a website.

Process 300 further comprises block 220 in which facilitator grants access to the disclosure to members of the public, who may search for prior art relevant to the invention. The access may be public, in which any member of the public may view the disclosure, or the invention may be private, in which only a defined group, for example, people who have committed to confidentiality, may view the disclosure. These members of the public or the defined group, for the sake of convenience, are designated “searchers.”

The disclosure may be made available through a website, for example in an invention showcase section of a website, either as an abridged disclosure or a non-abridged disclosure. The invention may be the subject of a patent or patent application which has been filed by the facilitator and/or the inventor or the invention may be not yet protected by a patent application patent or patent application which has been filed by the facilitator and/or the inventor. In either of these situations, a facilitator may request that that the searcher maintains confidentiality upon receipt of the invention disclosure.

The searcher may be requested to find relevant prior art which has been published before a date. The date may be the date of filing of a patent application on the invention or the date may be the date of invention.

Process 300 further comprises block 230 in which a searcher finds prior art and submits it to the facilitator. The searcher may provide relevant prior art electronically, for example, via a website.

Optionally, process 300 may further comprise block 240 in which prior art received from searchers is rated based on relevance to the invention by a facilitator or by searchers. The other searchers may grade prior art submitted by their fellow searchers based on the similarity between the prior art and the invention.

Process 300 further optionally comprises block 250 in which prior art is publicly made available to a potential investor. An investor may review the prior art found or the prior art graded as most relevant to the invention and decide on his investment based on the search performed.

Process 300 further optionally comprises block 260 in which searcher is rewarded for providing prior art to facilitator. The prior art provider may be rewarded with a monetary reward or with a credit which can be used for bidding or payment for rights in inventions in a CIDS system. The credit may be used towards bidding or payment for rights in the same invention regarding which the searcher found prior art, or for a different invention in a CIDS system for which the searcher did not find prior art.

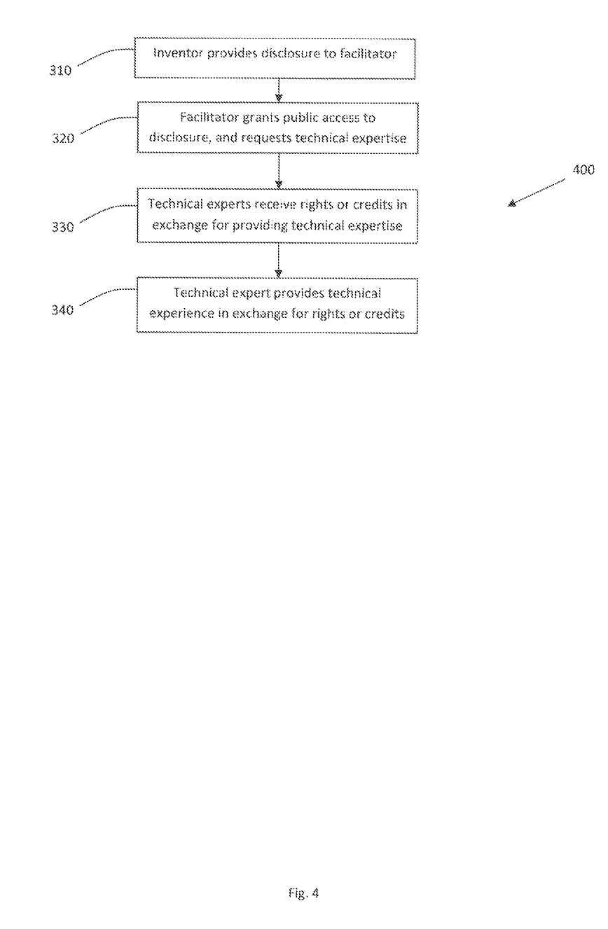

With reference to FIG. 4, process 400 is a CIDS process according to an embodiment of the invention. In process 400 an inventor is a CIDS process according to an embodiment of the invention. In process 400, an invention is provided to a facilitator and facilitator requests technical expertise from one or more technical expert, for example, using crowdsourcing. If a technical expert provides technical expertise relevant to the invention, the facilitator may then reward the technical expert who provided the relevant technical expertise with credit which can be used to purchase rights in an invention.

According to an embodiment of the invention, process 400 comprises block 310, in which an inventor provides a disclosure of the invention to a facilitator, optionally through a website.

Process 400 further comprises block 320 in which facilitator grants access to the disclosure to members of the public, who may provide technical expertise relevant to the invention. The access may be public, in which any member of the public may view the disclosure, or the invention may be private, in which only a defined group, for example, people who have committed to confidentiality, may view the disclosure. Members of the group may be rated, either by other members of the group, or by the facilitator, based on parameters such as education, experience, or previous participation in providing technical expertise to a facilitator.

The disclosure may be made available through a website, for example in an invention showcase section of a website, either as an abridged disclosure or a non-abridged disclosure. The invention may be the subject of a patent or patent application which has been filed by the facilitator and/or the inventor or the invention may be not yet protected by a patent application patent or patent application which has been filed by the facilitator and/or the inventor. In either of these situations, a facilitator may request that that the technical expert maintains confidentiality upon receipt of the invention disclosure.

Process 400 further comprises block 330 in which a technical expert submits technical expertise to the facilitator. The searcher may provide relevant prior art electronically, for example, via a website or a telephone or video conference.

Process 400 further optionally comprises block 440 in which a technical expert is rewarded for providing technical expertise to facilitator. The technical expert may be rewarded with a monetary reward or with a credit which can be used for bidding or payment for rights in inventions in a CIDS system. The credit may be used towards bidding or payment for rights in the same invention regarding which the technical expert provided expertise, or for a different invention in a CIDS system for which the technical expert did not provide expertise.

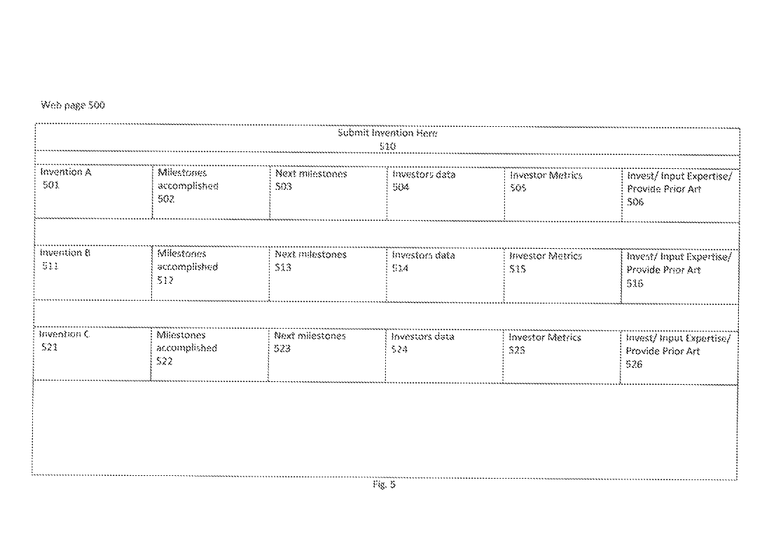

FIG. 5 schematically depicts an invention showcase section of a web site, designated web page 500, according to an embodiment of the invention. The website may be a website which facilitates a CIDS system, and may be maintained by a facilitator, according to an embodiment of the invention. Web page 500 may comprise buttons, or clickable text, which may be selected and may activate a hyperlink to lead a user to another site.

In web page 500, inventions A, B and C are showcased in boxes 501, 511 and 521 respectively. Each of boxes may 501, 511 and 521 may comprise a brief description of an invention. The brief description may comprise a description of the need for the invention, the problem that the invention solves or a picture of an embodiment of the invention. Boxes 501, 511, and 521 may comprise buttons which lead users to web pages detailing more information about inventions A, B and C respectively.

Web page 500 may further comprise boxes 502, 512 and 522, which address the milestones which have been accomplished for inventions A, B and C respectively. Milestones may include research milestones, market milestones or patent milestones. Boxes 502, 512 and 522 may comprise buttons which lead users to web pages detailing more information about milestones relative to inventions A, B and C respectively.

Web page 500 may further comprise boxes 503, 513 and 523, which address future, planned milestones which are intended for inventions A, B and C respectively. Milestones may be associated with a milestone cost, which also may be displayed in boxes 503, 513 and 523. Boxes 503, 513 and 523 may comprise buttons which lead users to web pages detailing more information about future planned milestones relative to inventions A, B and C respectively.

Web page 500 may further comprise boxes 504, 514 and 524, which address investor data. Investor data may comprise information regarding identity of investors, number of investors and frequency of investment. Boxes 504, 514 and 524 may comprise buttons which lead users to web pages detailing more information about investor data relative to inventions A, B and C respectively.

Web page 500 may further comprise metrics in boxes 505, 515, and 525, as relevant to investors or investment associated with inventions A, B and C respectively.

Web page 500 may further comprise boxes which address inventor data. Inventor data may comprise information regarding identity of inventors, or numbers of inventors attributed to each of the investors (boxes not shown in FIG. 5.) Such boxes may comprise buttons which lead users to web pages detailing additional inventions relating to each inventor.

Web page 500 may further comprise boxes 506, 516 and 526 which may comprise buttons linking to web pages which allow users of web page 500 to invest, provide technical input to facilitator or provide relevant search information to facilitator with respect to inventions A, B and C respectively.

Other information that may be displayed includes information about a potential market for the invention. This information may include potential annual sales or other similar projected market data.

Web page 500 may further compose buttons which allow a user to arrange the display of the website according to various parameters and arrange inventions according to user's interest.

Web page 500 may comprise a search window which allows a user to search web page 500 for text, figures or data according to user's input string.

In the description and claims of the present application, each of the verbs, “comprise,” “include” and “have,” and conjugates thereof, are used to indicate that the object or objects of the verb are not necessarily a complete listing of components, elements or parts of the subject or subjects of the verb.

Descriptions of embodiments of the invention the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method for development of an inventor's invention, comprising:
publishing a plurality of descriptions of inventions in a publicly accessible database; and publishing a request to receive information relevant to an invention listed in the publicly accessible database in exchange for rights in an invention listed in the publicly accessible database.

2. The method according to claim 1 wherein the information relevant to an invention comprises information relevant to prior art associated with the invention or information relating to development and reduction to practice of the invention.

3. The method according to claim 1 further comprising receiving information relevant to an invention from a contributor.

4. The method according to claim 3 further comprising rewarding a contributor with rights or credit to purchase rights in an invention in the database.

5. The method according to claim 4 wherein the contributor is rewarded with rights or credit to purchase rights in the invention regarding which the contributor provided information.

6. The method according to claim 4 wherein the contributor is rewarded with rights or credit to purchase rights in an invention other than the invention regarding which the contributor provided information.

7. The method according to claim 1 wherein the publicly accessible database is a website.

8. The method according to claim 1, further comprising:
accepting a payment or bid for payment from a first potential investor or a first group of potential investors as an investment in the invention in return for rights in the invention, or receiving input from a first potential investor or a first group of potential investors in connection to an invention; calculating a metric based on the input received from the first potential investor or first group of potential investors; and
displaying the metric on the publicly accessible database to a second group of potential investors.

9. The method according to claim 8 wherein the metric is calculated based on one or more of: potential investor interest, potential investor history; potential investor payment and potential investor rating.

10. The method according to claim 8 wherein the method further comprises allowing the second group of potential investors to invest in the invention in return for rights in the invention.

11. The method according to claim 8, further comprising calculating a metric based on a metric based data relating to an inventor; and displaying the metric on the publicly accessible database to a potential investor.

12. The method according to claim 3, further comprising determining a value of the invention based on the metric and displaying the value of the invention on the publicly accessible database.

13. A method for development of an inventor's invention, the method comprising:
determining a plurality of development milestones associated with the invention;
determining a cost associated with a milestone; publishing an abridged description of the invention on a publicly accessible database which may be accessed by a plurality of potential investors; accepting payment or a bid fur payment from a first investor or group of investors in exchange for a right in the invention; filing a patent application relating to the invention; publishing a second description of the invention on the publicly accessible database; accepting a payment or a bid for payment from a second investor or group of investors in exchange for a right in the invention.

14. The method according to claim 13, wherein the cost per right for the second investor or group of investors is higher than the cost per right for the first investor or group of investors.

15. The method according to claim 13 wherein the publicly accessible database is a website.

16. The method according to claim 15 wherein the website comprises descriptions of a plurality of inventions configured to be viewed simultaneously at a user's terminal.

17. The method according to claim 13 wherein the second description of the invention comprises more information than the abridged description of the invention.

18. A computer, comprising at least one processor programmed with a computer executable instruction set executable to implement a method according to claim 1.

19. A computer, comprising at least one processor programmed with a computer executable instruction set executable to implement a method according to claim 13.
